(19) United States
(12) Patent Application Publication
(10) Pub. No.: US 2024/0021953 A1
(43) Pub. Date: Jan. 18, 2024

(54) VENT ADAPTOR AND BATTERY INCLUDING A VENT ADAPTER

(71) Applicant: CPS Technology Holdings LLC, New York, NY (US)

(72) Inventors: Arunraj Varatharajah, Menomonee Falls, WI (US); Jason Fuhr, Sussex, WI (US)

(21) Appl. No.: 18/033,655

(22) PCT Filed: Oct. 29, 2021
(86) PCT No.: PCT/US2021/057254

§ 371 Date: Apr. 25, 2023

Related U.S. Application Data
(60) Provisional application No. 63/108,103, filed on Oct. 30, 2020.

(51) Int. Cl. H01M 50/30; H01M 10/12

(52) U.S. Cl. CPC H01M 50/394; H01M 10/12

(57) ABSTRACT

A vent adaptor for placement inside a vent aperture that is itself placed within a battery housing. The vent adaptor has a cylindrical portion and a seal to create a gas-tight seal around the vent aperture. Along the upper portion of the vent adaptor are teeth which function to lock the vent adaptor in various configurations depending on the number and orientation of the various teeth and their interaction with various indentations in the vent aperture. The cylindrical portion may also have ribs with various geometries spaced at particular intervals to prevent the egress of the vent adaptor from the vent aperture. The vent adaptor may have internal diameter of at least 5 millimeters to accommodate an appropriately sized vent tube. A batten 7 with a housing that contains a vent aperture and a vent adaptor located inside the vent aperture.

### CROSS-REFERENCE TO RELATED APPLICATIONS

This application claims the benefit of US Patent Application No. 63/108,103, filed Oct. 30, 2020, the entirety of which is incorporated herein by reference.

### FIELD

This application relates to a battery that vents gas. More specifically, this application relates to a vent adaptor for use with a battery that vents gas.

### BACKGROUND

A battery, such as a vehicle battery, may have a vent aperture for venting gas from the battery. A vent tube (e.g., for the vehicle) may be inserted in the vent aperture to facilitate the egress of gas from the battery. In some situations, the vent tube for the vehicle does not properly fit the vent aperture for the battery. If the vent tube is too small (e.g., the exterior diameter of the vent tube is 6 mm) for the vent aperture (e.g., the inner diameter of the vent aperture is 8 mm), then an improper seal occurs between the vent tube and the vent aperture. An improper seal creates various issues such as egress of gas into undesired locations and decreased egress efficiency, among others. One solution is to redesign the vent tube or the vent aperture to create a proper seal. However, the design and implementation of such redesigns may be so costly or labor-intensive as to be impractical.

Accordingly, another alternative solution addressing the above deficiencies or other deficiencies is desired.

### SUMMARY

In embodiments, a vent adaptor, and a battery comprising a housing having an aperture in which the vent adaptor is disposed are disclosed.

In embodiments, the vent adaptor described includes a cylinder of a certain internal diameter to match with a corresponding vent tube and a seal in order to create an air-tight seal around the vent tube. It is envisioned that the external diameter of the cylinder may be manufactured with different measurements in order to accommodate user-specific needs.

In embodiments, the vent adaptor described includes one or more teeth, tabs, or projections arranged in certain angular orientations which align with corresponding indentations in a vent aperture in order to secure the vent adaptor in place within the vent aperture.

In embodiments, the cylinder of the vent adaptor includes a number of ribs with combinations of flat, curved, and angled geometries in order to prevent the egress of the vent adaptor from the vent aperture once the vent adaptor is inserted into the vent aperture.

### BRIEF DESCRIPTION OF THE DRAWINGS

FIG. 1 is a perspective view of a lead-acid battery.

FIG. 2 is a perspective view of the lead-acid battery of FIG. 1 with the cover removed.

FIG. 3 is a partially-exploded perspective view of the lead-acid battery of FIG. 1.

FIG. 4 is a sectional view of the lead-acid battery of FIG. 1 with electrolyte being injected into the battery.

FIG. 5 is a partial perspective view of a cover with no vent adaptor.

FIG. 6 is an elevated view of a portion of the cover of FIG. 5 with no vent adaptor and an adjacent vent adaptor.

FIG. 7 is a perspective view of the cover of FIG. 5 with the vent adaptor of FIG. 6 inserted.

FIG. 8 is a first perspective view of a vent adaptor.

FIG. 9 is a second perspective view of the vent adaptor FIG. 8,

FIG. 10 is a first side view of the vent adaptor of FIG. 8.

FIG. 11 is a second side view of the vent adaptor of FIG. 8.

FIG. 12 is an end view of the vent adaptor of FIG. 8.

FIG. 13 is a sectional view of the vent adaptor of FIG. 10 along line A-A.

FIG. 14 is a perspective view of a second construction of the vent adaptor.

FIG. 15 is an end view of the vent adaptor of Fla 14.

FIG. 16 a first side view of the vent adaptor of FIG. 14.

FIG. 17 is a first perspective view of a third construction of the vent adaptor.

FIG. 18 is a second perspective view of the vent adaptor of FIG. 17.

FIG. 19 is a sectional view of the vent adaptor of FIG. 17 along line B-B.

It should be understood that the drawings are not necessarily to scale. In certain instances, details that are not necessary to the understanding to the invention or render other details difficult to perceive may have been omitted. It should be understood, of course, that the invention is not necessarily limited to the apparatus or processes illustrated herein.

### DETAILED DESCRIPTION

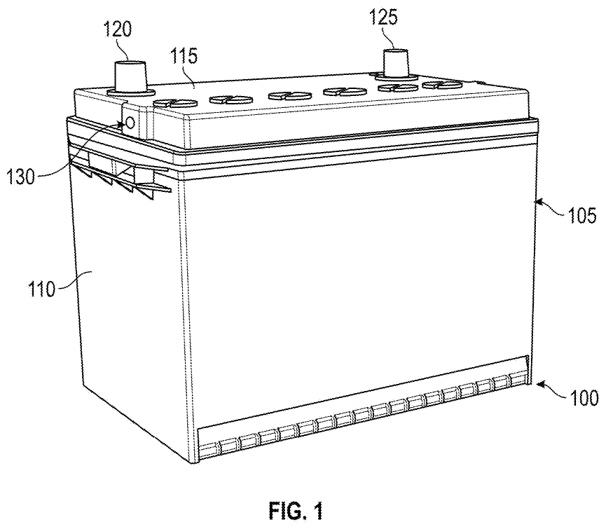

FIGS. 1-4 show a lead-acid battery 100 (e.g., a lead-acid battery for use with vehicles or other applications, including starting, lighting, and ignition batteries; a commercial battery; an industrial battery; a marine battery; etc.) having a housing 105. The shown lead-acid battery 100 is used for understanding the apparatus (or system) described herein. Other batteries, battery types, and apparatus can be used in alternative to the lead-acid battery 100.

With reference to FIG. 1, the housing 105 includes a base 110 and a cover 115. The cover 115 is secured to the base 110 (e.g., by heat sealing the cover 115 to the lead-acid battery 100 at various points). The lead-acid battery 100 further includes terminals 120, 125 (or bushings) protruding through or on the housing 105 (e.g., the cover 115 as shown), and a vent aperture 130 for venting gas through the housing 105. A vent tube (not shown) can be inserted in the vent aperture 130 to vent gas from the vent aperture 130 to another location (e.g., an exterior of the vehicle). The terminals 120, 125 are provided on the cover 115 for connecting or coupling the lead-acid battery 100 to electrical loads (e.g., a vehicle electrical system).

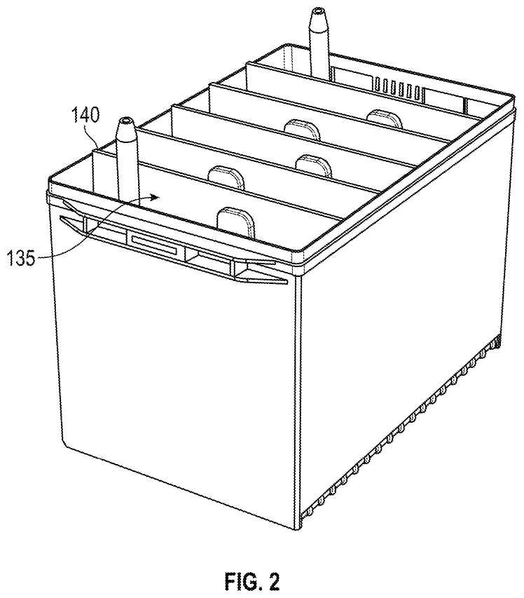

FIG. 2 shows the cover 115 removed. The battery housing 105 supports a plurality of battery cell compartments (one battery cell compartment 135 is labelled). The battery cell compartments 135 can be formed by the housing 105 and a plurality of cell walls or partitions (one wall 140 is labelled) that define the plurality of battery cell compartments 135. The partitions 140 may be formed as being unitary with the housing 105. While the construction discussed herein has six battery cell compartments 135, a different number of battery cell compartments 135 may be provided. Further, while the shown battery cell compartments 135 are generally rectangular in shape, other shapes may be used for the battery cell compartments 135. The battery cell compartments 135 (and related battery cells) may conventionally be referred to by number (e.g., a six-cell battery would have cells 1, 2, 3, 4, 5, and 6). According to an example embodiment in which a battery is provided as having six cells, five partitions are provided, one of which is provided between each of the six cells.

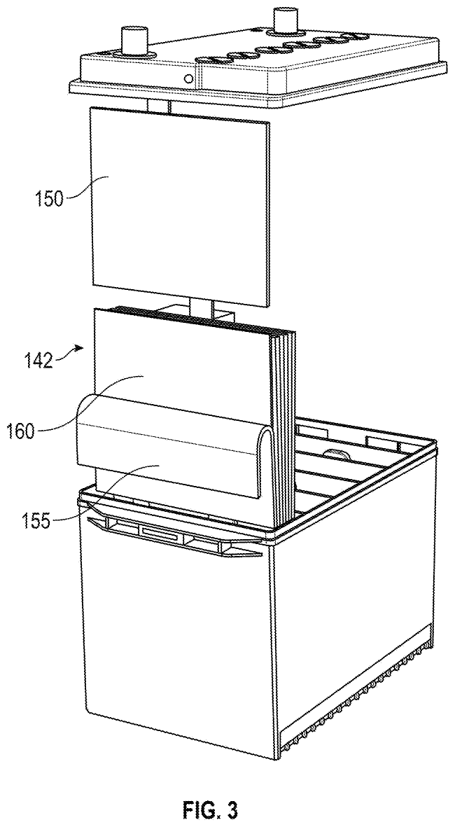

FIG. 3 shows one of a plurality of battery cells (one cell 140 is labeled) in a partially exploded view. The battery cell 140 includes a plurality of positive frames or plates, a plurality of separators partially surrounding the positive frames, and a plurality of negative frames or plates. FIG. 3 has one positive frame 150, one separator 155, and one negative frame 160 labelled.

In a lead-acid battery, the positive and negative frames each comprise a lead or lead-alloy grid that serves as a substrate and supports an electrochemically active material deposited or otherwise provided thereon during manufacture to form the battery frames. The grids provide an electrical contact between the positive and negative active materials or paste which serves to conduct current.

Separators are provided between the frames to prevent shorting and/or undesirable electron flow produced during the reaction occurring in the battery. Positive and negative electrode frames can be classified into various types according to the method of manufacturing. In one or more examples, each frame has a generally rectangular shape and includes a lug which is electrically coupled to a battery terminal. The frame also may include side walls, a bottom edge, and opposing faces.

The one or more battery separators are used to conductively separate the positive and negative electrodes. A separator material, utilized to separate adjacent, plates from one another, has sufficient porosity and retention to contain at least substantially all of the electrolyte necessary to support the electrochemical reactions. In various examples, the separator material is compressible so that upon stacking of the elements, the separator material substantially conforms to the contour of the surface of the plates to help it perform its wicking or capillary action.

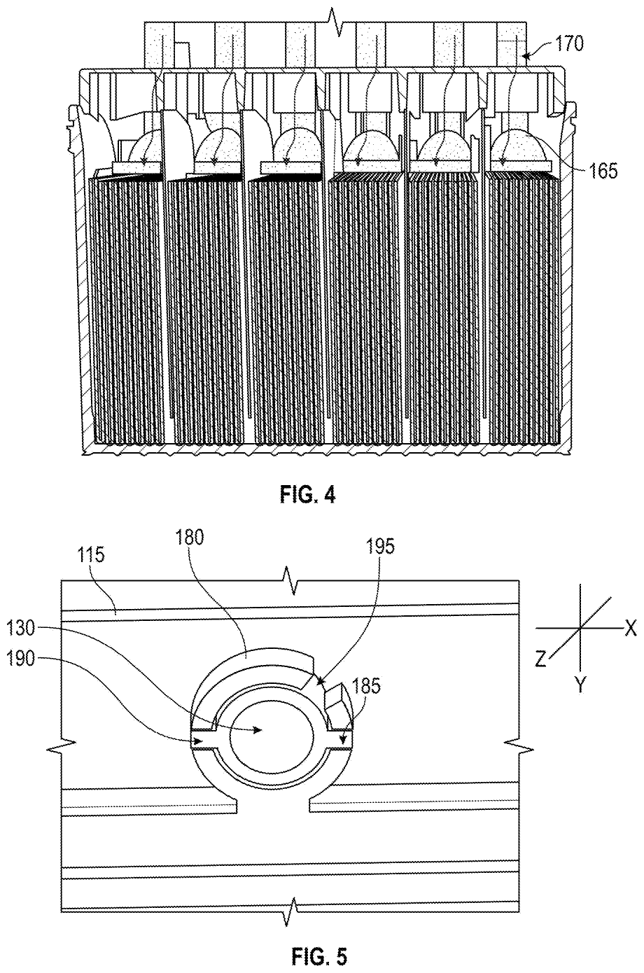

In one or more examples, the separator may be similar in design anchor construction to that previously used for sealed lead-acid batteries operating on the oxygen recombination principle, in particular separators of a highly porous mat of ultrafine glass fibers. For example, in various examples, the separator is constructed of an absorbent glass mat (AGM). In various examples, the non-woven mat includes a polymeric component such as polypropylene and/or polyethylene. In various examples, the AGM is a non-woven fabric including glass micro-fibers that are intended to retain electrolyte (e.g.,, by capillary action) but also provide gas spaces as long as the grid is not fully saturated with electrolyte. The electrolyte is still free to move but is more confined than in a flooded cell. Other known and later developed separator materials may also or alternatively be used in connection with the cell including, without limitation, microporous rubber, polyvinyl chloride, polyolefin, and phenolic resin impregnated paper. FIG. 4 shows an electrolyte 165 being injected through apertures (one aperture 170 is labelled) of the cover 115.

The lead-acid battery 100 discussed thus far in FIGS. 1-4 is an example type of a lead-acid battery known in the art. A person of ordinary skill in the battery art would understand that other lead-acid battery types, designs, and/or arrangements can be used in alternative to the lead-acid battery 100 shown in FIGS. 1-4.

In some situations, the vent tube for the vehicle does not properly fit the vent aperture for the battery. If the vent tube is too small (e.g., the exterior diameter of the vent tube is 6 mm) for the vent aperture (e.g., the inner diameter of the vent aperture is 8 mm), then an improper seal occurs between the vent tube and the vent aperture. Rather, than changing the size of either the vent tube or the vent aperture, a vent adaptor can be used to help couple the vent tube to the vent aperture, thereby resulting in a proper seal.

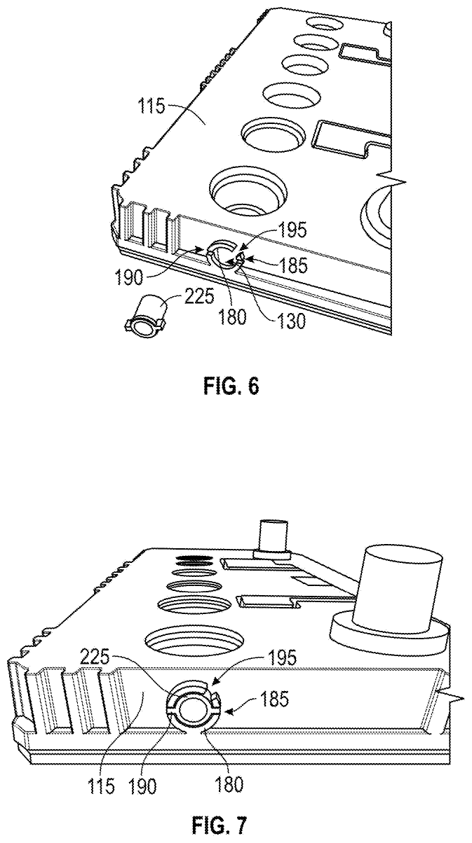

The cover 115 in FIGS. 5-7 shows a vent aperture 130. On the exterior of the cover 115 and surrounding the vent aperture 130 is a lip or rim 180 with a number of indentations 185, 190, 195. Three indentations 185, 190, 195 are shown. A first indentation 185 lies perpendicular to the housing 105 in the X axis. A second indentation 190 is 180 degrees along the edge of the lip 180 from the first indentation 185. A third indentation 195 is 45 degrees along the edge of the lip 180 from the first indentation 185. Other locations and further indentations are possible.

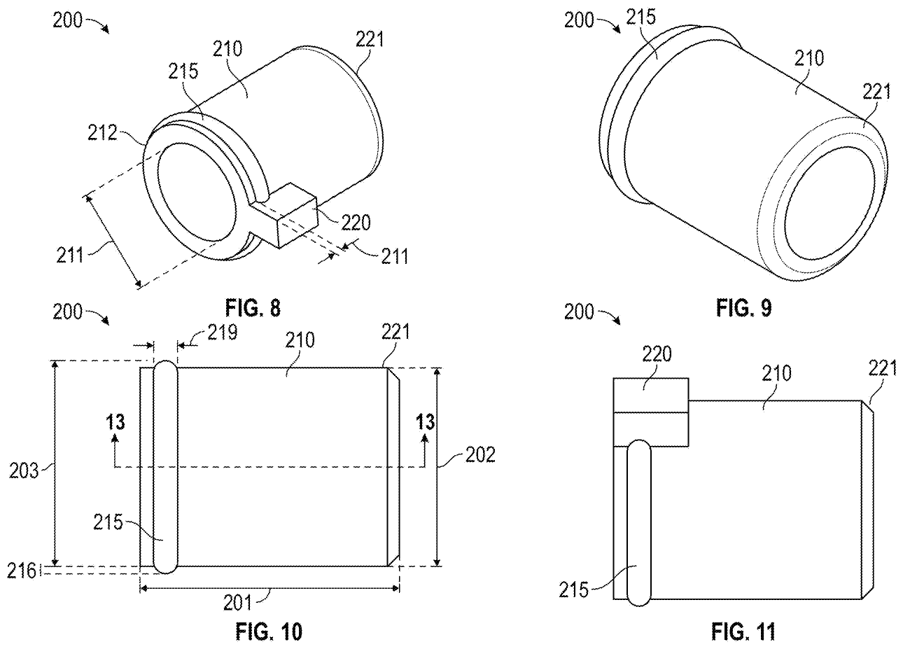

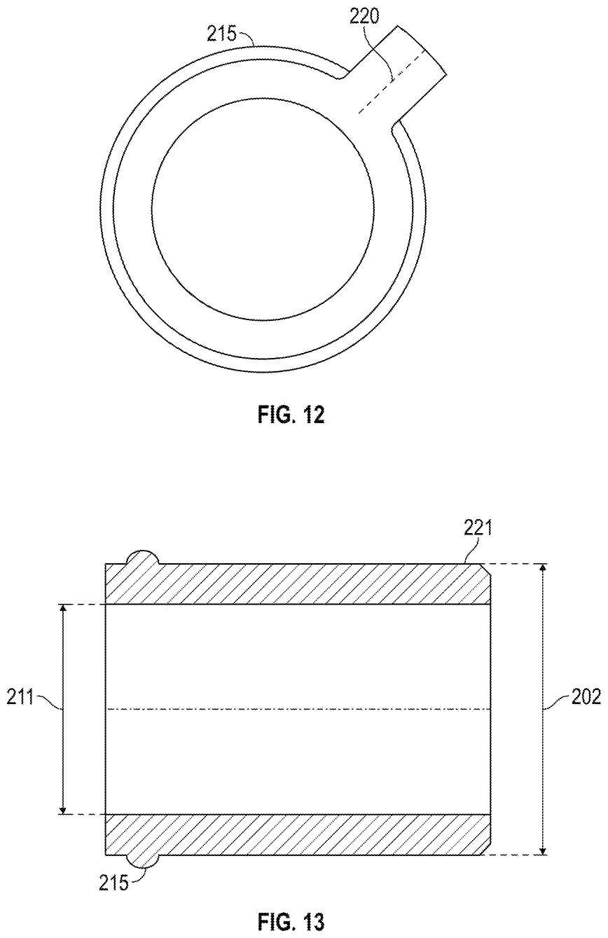

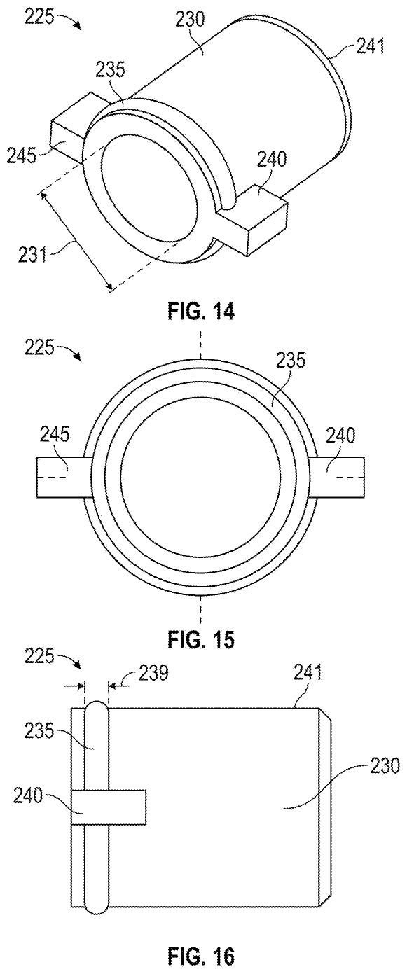

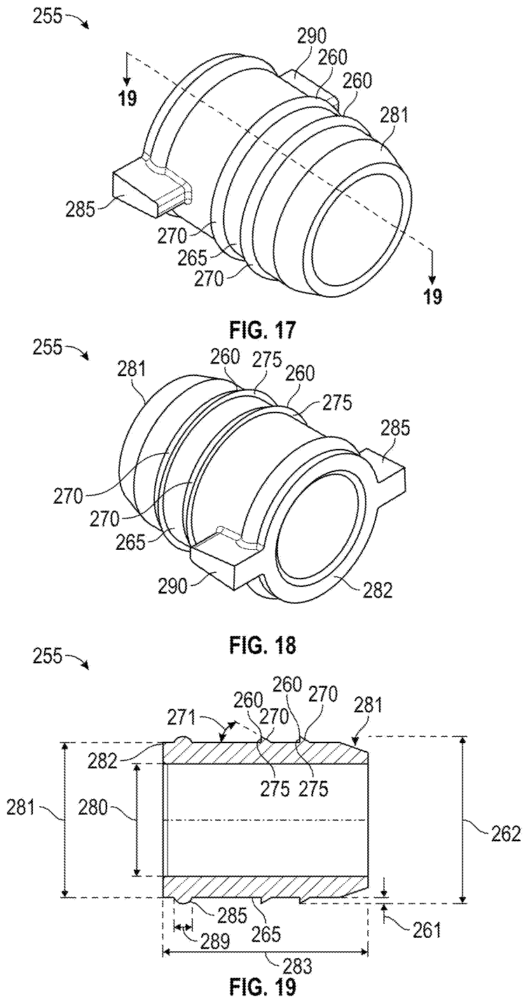

A first vent adaptor 200 is shown in FIGS. 8-13. A second vent adaptor 225 is shown in FIGS. 14-16. A third vent adaptor 255 is shown in FIGS. 17-19.

The three vent adaptors 200, 225, 255 include a cylinder 210, 230, 265 with an internal diameter 211, 231, 280, a seal 215, 235, 285 surrounding the cylinder 210, 230, 265 and a number of teeth or tabs or projections 220, 240, 245, 285, 290. It is envisioned that the location of the seal 215, 235, 285, the type of seal 215, 235, 285, the dimensions of the seal 215, 235, 285, and the material used for the seal 215, 235, 285 (e.g., being different from the material of the cylinder 210, 230, 265) can vary from what is shown and described herein.

For the constructions shown, the seal 215, 235, 285 is integrated with the cylinder 210, 230, 265 and is made of the same material as the cylinder 210, 230, 265. The shown seal 215, 235, 265 is an arcuate-shaped seal with a seal length 219, 229, 289 that provides a compressed friction fit between the vent adaptor 200, 225, 255 and the vent aperture 130, particularly when the vent adaptor 200, 225, 255 is inserted into the vent aperture 130 and the vent tube (not shown) is inserted into the vent adaptor 220, 225. 255. Other seal shapes may include a wedge-shaped seal or a flat seal. One skilled in the art will appreciate that other seal shapes and geometries may be preferred based on needs.

For the construction shown in FIGS. 8-13, the vent adaptor 200 includes a single tooth 220. For the construction shown in FIGS. 14-16, the vent adaptor 225 includes two teeth 240, 245. For the construction shown in FIGS. 17-19, the vent adaptor includes two teeth 285, 290. For FIGS. 14-16, the first tooth 240 and second tooth 245 are positioned opposite one another (e.g., are spaced 180 degrees apart along the outer circumference of the cylinder 230). It is alternatively envisioned that the first tooth 240 is spaced 45 degrees from the second tooth 245 along the outer circumference of the cylinder 230. Other spacings are possible.

For the shown construction, the teeth 220, 240, 245, 285, 290 allow for placement of the vent adaptor 200, 225, 255 in the vent aperture 130. For example, the dimensions of the teeth 220, 240, 245, 285, 290 allow for the vent adaptor 200, 225, 255 to be inserted into the vent aperture 130 and to stop being inserted at a designated position. The location of the teeth 220, 240, 245, 285, 290 can also be used to create an orientation of the vent adaptor 200, 225, 255. For example, the construction shown in FIGS. 14-16 can result in one of two orientations. The vent adaptor 225 having the first tooth 240 that is spaced 45 degrees from the second tooth 245 along the outer circumference of the cylinder 230 results in a single orientation for the vent adaptor 225. One skilled in the art will appreciate that any number of different orientations may be possible or preferred based on individual needs.

In other embodiments, a vent adaptor 255 may have ribs 260 along the cylinder 265 to further prevent the egress of the vent adaptor 255 from the vent aperture 130. The ribs 260 may be made from the same material as the cylinder 265 or from a different material. Two ribs 260 are shown in the example construction, but one skilled in the art will realize that more or fewer ribs 260 may be preferable in order to fulfill specific needs. While the ribs 260 are shown as having an angled portion 270 and a flat portion 275, other combinations and orientations of angled portions, curved portions, and/or flat portions may be imagined. The addition of ribs 260 may be possible in combination with any of the example vent adaptors 200, 225, 255 or in combination with any other configuration as described herein.

It is also envisioned that the lip 180 may not include any indentations 185, 190, 195, or the lip 180 may not be present. Further, the portion of the vent adaptors 200, 225, 255 that first contact the vent aperture 130 upon insertion may have a chamfer 221, 241, 281 that may facilitate the insertion process.

As an example construction, the first vent adaptor 200 as shown has a total length 201 (e.g., 10.5 mm) and an external diameter 202 (e.g., 8 mm). Other example constructions not shown herein may have similar or different dimensions to those of the first vent adaptor 200. The dimensions of the adaptors 200, 240, 255 depicted in the FIGS. 10-13, 15-16, and 19 are representative dimensions for the three example constructions shown herein. The ratios and the dimensions, in one construction, can vary by ±10%. The ratios and the dimensions, in another construction, can vary by ±5%.

As an example construction, the first vent adaptor 200 as shown has a seal 215 with a position on the cylinder 210 defined by a distance 211 (e.g., 0.5 mm) from the external end 212 to the start of the seal. In one embodiment, the distance 211 from the external end 212 may be between 1 and 15% of the total length. In another embodiment, the distance 211 from the external end 212 may be between 2 and 10% of the total length 201. In yet another embodiment, the distance 211 from the external end 212 may be between 3 and 5% of the total length 201.

In other example constructions, the seal height 216 may vary. For example, the first vent adaptor 200 has a seal 215 with a seal height 216 defined by the ratio between the seal diameter 203 and the external diameter 202. In a preferred embodiment, the ratio between the seal diameter 203 and the external diameter 202 may be between 1.01 and 1.10. In another preferred embodiment, the ratio between the seal diameter 203 and the external diameter 202 may be between approximately 1.02 and 1.05. Other embodiments will be appreciated by those skilled in the art.

In other example constructions, the rib height 261 may vary. For example, the third vent adaptor 255 has ribs 260 with a rib height 261 defined by the ratio between the rib diameter 262 and the external diameter 281. In preferred embodiments, the ratio between the rib diameter 262 and the external diameter 281 may be between 1.01 and 1.10. In other preferred embodiments, the ratio between the rib diameter 262 and the external diameter 281 may be between 1.02 and 1.05.

In other example constructions, the position of the ribs 260 on the cylinder 265 may vary. For example, the third vent adaptor 255 has a number of ribs 260 located on the cylinder 265 a certain distance from the external end 282 (e.g., 5.5 mm). In a preferred embodiment, the distance from the external end 282 of any of the number of ribs 260 may be between 30 and 80% of the total length 283. ln other preferred embodiments, the distance from the external end 282 of any of the number of ribs 260 may be between 40 and 75% of the total length 283. In yet another preferred embodiment, the distance from the external end 282 of any of the number of ribs 260 may be between 50 and 70% of the total length 283.

In other example constructions, the angle 271 of the ribs 260 may vary. For example, the third vent adaptor 255 has a number of ribs 260 with an angle 271 between approximately 15 and 45 degrees measured from the cylinder 265. In a preferred embodiment, the angle 271 may be between 25 and 35 degrees measured from the cylinder 265.

In other example constructions, the shape of the ribs 260 may vary. For example, the third vent adaptor 255 has a number of ribs 260 with a wedge shape defined by an angled portion 270 and a flat portion 275. In other embodiments, the shape of the ribs may comprise a grooved shape or an arcuate shape. One skilled in the art will appreciate that any number of other shapes may be utilized depending on specific needs.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

The terms fixedly, non-fixedly, and removably, and variations thereof, may be used herein. The term fix, and variations thereof, refer to making firm, stable, or stationary. It should be understood, though, that fixed doesn't necessarily mean permanent rather, only that a significant or abnormal amount of work needs to be used to make unfixed. The term removably, and variations thereof, refer to readily changing the location, position, station. Removably is meant to be the antonym of fixedly herein. Alternatively, the term non-fixedly can be used to be the antonym of fixedly.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g., by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A vent adaptor for receipt in a vent aperture of a battery, the vent adaptor comprising:
a cylinder having a total length, an external end, and an internal end; and
a seal integrated with the cylinder having a seal diameter.

2. The vent adaptor of claim 1, further comprising a first projection integrated with the cylinder.

3. The vent adaptor of claim 2, further comprising a second projection integrated with the cylinder.

4. The vent adaptor of claim 3, wherein the cylinder has an outer surface having a circumference, and wherein the second projection is 180 degrees from the first projection along the circumference.

5. The vent adaptor of claim 3, wherein the cylinder has an outer surface having a circumference, and wherein the second projection is less than 180 degrees from the first projection along the circumference.

6. The vent adaptor of claim 3, wherein the cylinder has an outer surface having a circumference, and wherein the second projection is less than 90 degrees from the first projection along the circumference.

7. The vent adaptor of claim 1, wherein the cylinder has one or more ribs.

8. The vent adaptor of claim 7, wherein the one or more ribs comprise a wedge shape formed by an angled portion and a flat portion.

9. The vent adaptor of claim 7, wherein the one or more ribs comprise an arcuate shape.

10. The vent adaptor of claim 8, wherein the angled portion comprises an angle between approximately 15 and 45 degrees.

11. (canceled)

12. The vent adaptor of claim 7, wherein the one or more ribs are located a distance from the external end of the cylinder of approximately 30-80% of the total length of the cylinder.

13. (canceled)

14. (canceled)

15. (canceled)

16. The vent adaptor of claim 1, wherein the seal is located a distance from the external end of the cylinder of approximately 3-5% of the total length of the cylinder.

17. (canceled)

18. (canceled)

19. The vent adaptor of claim 1, wherein the seal has a height defined by a ratio between the seal diameter and an external diameter of the cylinder.

20. (canceled)

21. The vent adaptor of claim 19, wherein the ratio is between approximately 1.01 and 1.10.

22. The vent adaptor of claim 1, wherein the seal is an arcuate seal and a circular seal.

23. (canceled)

24. The vent adaptor of claim 1, wherein the internal end is chamfered.

25. A battery comprising:
a housing having a vent aperture; and
the vent adaptor of claim 1 disposed in the vent aperture.

26. The battery of claim 25, wherein the vent aperture comprises a lip further comprising one or more indentations.

27. The battery of claim 26, wherein the vent aperture comprises one indentation.

28. (canceled)

29. (canceled)

30. The battery of claim 26, wherein the vent aperture comprises three indentations, two of which are spaced 180 degrees apart from one another and the third of which is spaced between approximately 30 and 90 degrees from either of the other two indentations.
